(19) United States
(12) Patent Application Publication
(10) Pub. No.: US 2013/0276580 A1
(43) Pub. Date: Oct. 24, 2013

(54) TOOL TROLLEY FOR ELECTROLYSIS MULTIFUNCTIONAL MACHINE SET

(71) Applicants: Cairong Chen, Gui Yang (CN); Lizhen Kong, Gui Yang (CN); Guanghua Lv, Gui Yang (CN); Xiaoming Duan, Gui Yang (CN); Shengfei Liu, Gui Yang (CN); Hong Liu, Gui Yang (CN); Yan Yan, Gui Yang (CN)

(72) Inventors: Cairong Chen, Gui Yang (CN); Lizhen Kong, Gui Yang (CN); Guanghua Lv, Gui Yang (CN); Xiaoming Duan, Gui Yang (CN); Shengfei Liu, Gui Yang (CN); Hong Liu, Gui Yang (CN); Yan Yan, Gui Yang (CN)

(21) Appl. No.: 13/508,118

(22) PCT Filed: Nov. 3, 2010
(86) PCT No.: PCT/CN2010/001765

§ 371 Date: Dec. 17, 2012

(30) Foreign Application Priority Data
Nov. 5, 2009 (CN) 200920314109.7

(51) Int. Cl. C25C 7/06; B23Q 16/10

(52) U.S. Cl. CPC C25C 7/06; B23Q 16/10
USPC 74/813 R

(57) ABSTRACT

A tool trolley for an electrolysis multifunctional machine set comprises: a frame (1); a hopper (2) fixed to the frame; a tool rotarytable (3) disposed at the lower portion of the hopper and rotatable around the hopper; an operating cab (4) disposed below the center of the tool rotarytable; a crust breaking tool (5), an anode replacing tool (6), a grab bucket tool (7) for cleaning anode pit and a feeding tool (8) of the tool rotarytable flexibly connected to the tool rotarytable disposed around the operating cab; a rotation drive mechanism (13) disposed between the hopper and the tool rotarytable. The tools are radially configured around the operating cab which is rotatable within ±190 degrees or stationary, and meanwhile, the operating console in the operating cab may also be rotated ±90 degrees. Therefore, it is convenient for operation, and the operator is provided with a wider view. The tool trolley is simple in structure, and can be installed and maintained in an easier and quicker manner. The configuration of such a tool trolley breaks through the conventional manners, and the product is more novel in appearance.

### TECHNICAL FIELD

The present invention relates to a tool trolley for an electrolysis multifunctional machine set.

### BACKGROUND ART

During more than two decades from the middle and late 1980's to the present, electrolysis multifunctional machine sets have been produced in large quantities with some changes in the shape and function thereof, but the techniques used in general do not depart from the conventional ones. The designing techniques of electrolysis multifunctional machine sets actually still use conventional equipment structures, and various so-called improvements are only reproduction of the conventional techniques and lack novelty. This is particularly true for tool trolleys for electrolysis multifunctional machine sets. Current tool trolleys have not big changes in structure compared with traditional tool trolleys, and still have a relatively complicated structure, and are inconvenient in installation and maintenance, which restrains marketing competition of the electrolysis multifunctional machine sets produced by many enterprises.

### SUMMARY OF THE INVENTION

An object of the present invention is to overcome at least one drawback of conventional tool trolleys or to at least achieve the basic function of conventional tool trolleys using a different configuration.

Another object of the present invention is to provide a tool trolley for an electrolysis multifunctional machine set, which changes the traditional configuration so as to make the electrolysis multifunctional machine set with the tool trolley of the present invention more competitive in the market.

Particularly, the present invention provides a tool trolley for an electrolysis multifunctional machine set, comprising: a frame; a hopper fixed to the frame; a tool rotarytable disposed at the lower portion of the hopper and rotatable around the hopper; an operating cab disposed below the center of the tool rotarytable; a crust breaking tool, an anode replacing tool, a grab bucket tool for cleaning anode pit, and a feeding tool, which are flexibly connected to the tool rotarytable around the operating cab; and a rotation drive mechanism (13) disposed between the hopper and the tool rotarytable.

Preferably, the anode replacing tool is a single anode replacing tool or a double anode replacing tool.

Preferably, the tool rotarytable is provided with a set of concave openings and expansion slots; and the crust breaking tool, the anode replacing tool, the grab bucket tool for cleaning anode pit and the feeding tool are flexibly fixed in the concave openings, respectively.

Preferably, the tool rotarytable is provided with a hydraulic station and a power control cabinet.

Preferably, the operating cab is provided therein with an operating console which is rotatable within ±90 degrees.

In contrast with the prior art, the present invention adopts the following technical solutions, i.e., the tools are radially configured around the operating cab which is rotatable within ±190 degrees or stationary, while the operating console in the operating cab can also be rotatable, so that it is more convenient for operation, and the operator is provided with a wider view. The present invention is simple in structure, and can be installed and maintained in an easier and quicker manner. The present invention breaks through the prior art tool trolley configuration, so the product is more novel in appearance, in such a way that the electrolysis multifunctional machine set using the tool trolley of the present invention is more competitive in the market.

### BRIEF DESCRIPTION OF THE DRAWINGS

FIG. 1 is a structural schematic view of a tool trolley for an electrolysis multifunctional machine set according to the present invention;

FIG. 2 is a C-direction view of FIG. 1;

FIG. 3 is a K-direction view of FIG. 1;

FIG. 4 is a schematic view wherein a single anode replacing mechanism in FIG. 3 is replaced by a double anode replacing mechanism;

FIG. 5 is a sectional view of the tool trolley configured with the single anode replacing mechanism, taken along the line A-A of FIG. 1; and

FIG. 6 is a sectional view of the tool trolley configured with the double anode replacing mechanism, taken along the line A-A of FIG. 1.

The following reference signs are used in the drawings:

1—frame; 2—hopper; 3—tool rotarytable; 4—operating cab; 5—crust breaking tool; 6—anode replacing tool; 7—grab bucket tool for cleaning anode pit; 8—feeding tool; 9—hydraulic station; 10—power control cabinet; 11—concave openings; 12—operating console; 13—rotation drive mechanism; 14—expansion slots

### DETAILED DESCRIPTION OF THE PREFERRED EMBODIMENTS

The present invention is further described in detail in conjunction with the drawings and embodiments; however, the detailed description shall not be construed as any limitation to the scope of the present invention.

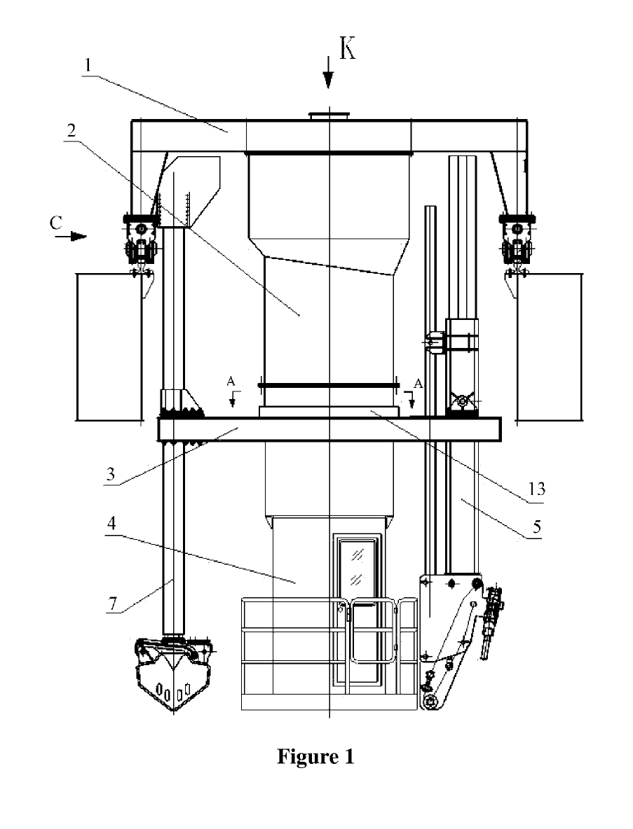

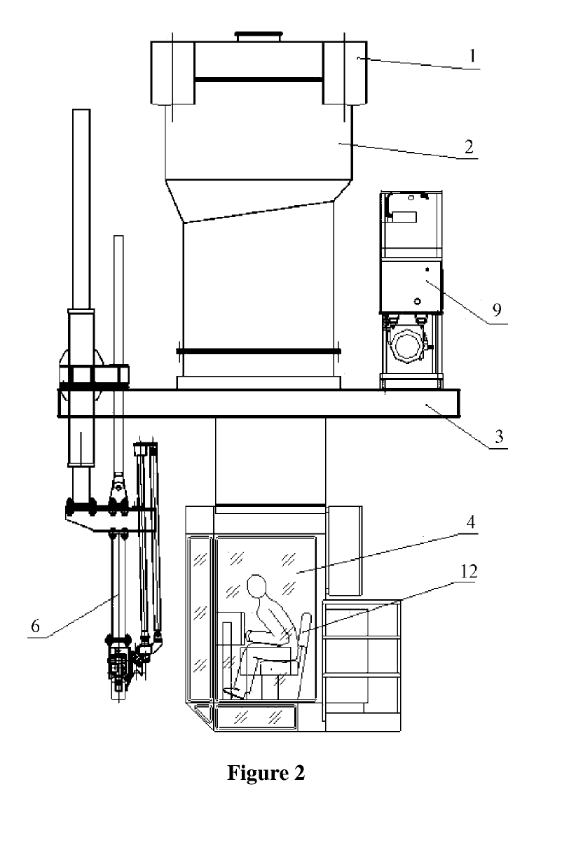

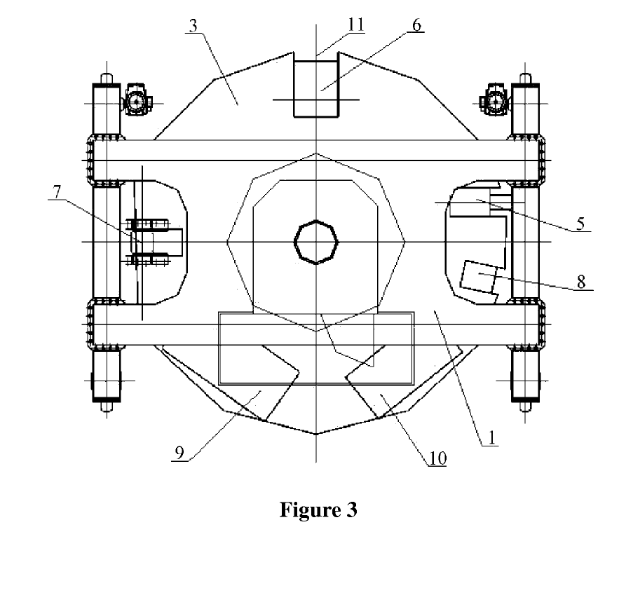

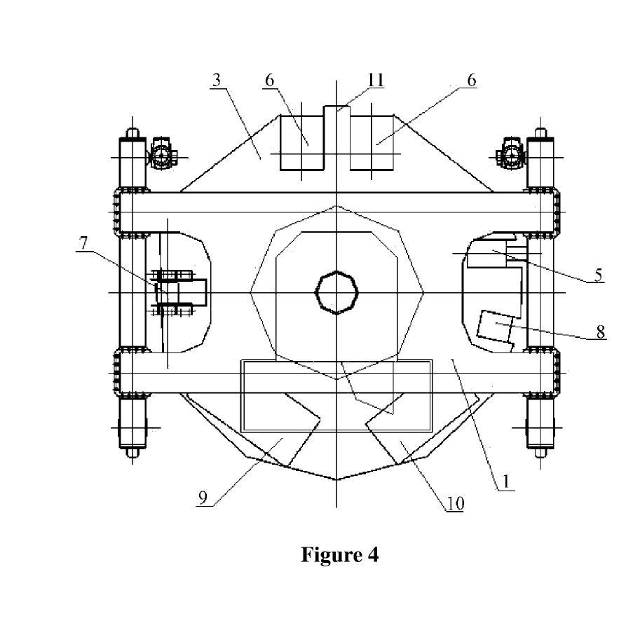

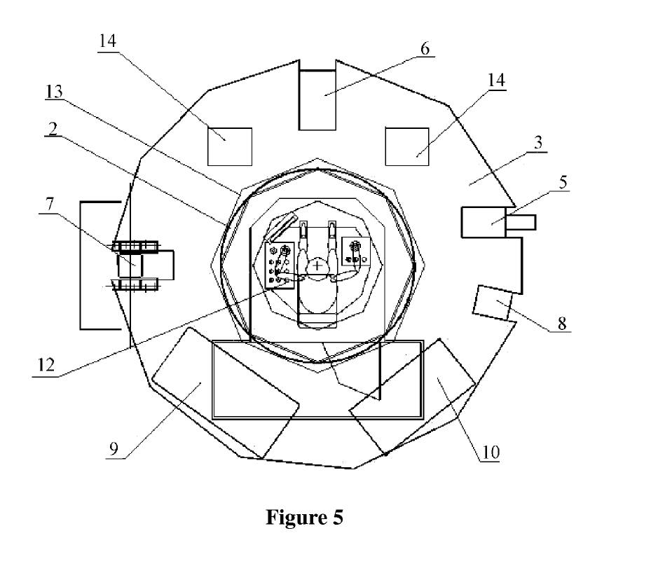

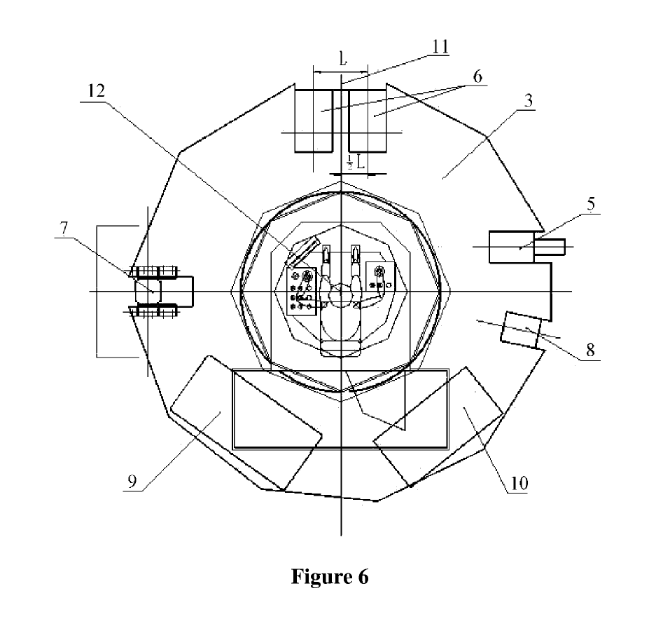

With reference to FIGS. 1-6, a tool trolley for an electrolysis multifunctional machine set according to the present invention comprises: a frame 1; a hopper 2 fixed to the frame 1; a tool rotarytable 3 disposed at the lower portion of the hopper 2 and rotatable around the hopper 3; an operating cab 4 disposed below the center of the tool rotarytable 3. That is to say, the operating cab 4 is at the rotation center, and a crust breaking tool 5, an anode replacing tool 6, a grab bucket tool 7 for cleaning anode pit and a feeding tool 8 flexibly connected to the tool rotarytable 3 are disposed around the operating cab 4. Various tools are disposed around the operating cab 4, and an operating console 12 is provided within the operating cab 4, the operating console 12 being rotatable within ±90 degrees. Each tool is viewable in the operating tab 4, and the operator can face each of the different tools to allow a best operational view by rotating the operating console 12. A rotation drive mechanism 13 is disposed between the hopper 2 and the tool rotarytable 3. The tool rotarytable 3 is also provided with expansion slots 14a reserved for potential future open-close groove cover tools and other means, thereby providing the present invention with good functional expansibility. On the tool rotarytable 3 is provided a hydraulic station 9 and a power control cabinet 10. The tool rotarytable 3 is provided with concave openings 11 and expansion slots 14; and the crust breaking tool 5, the anode replacing tool 6, the grab bucket tool 7 for cleaning anode pit and the feeding tool 8 are flexibly fixed in the concave openings 11, respectively. The expansion slots 14 are reserved for future addition of new tools. The anode replacing tool 6 may be a single anode replacing tool 6 (see FIG. 5), or may be a double anode replacing tool 6 (see FIG. 6). If the double anode replacing tool 6 is used (see FIG. 4), the center-to-center distance of two double anode replacing tools 6 is equal to the center-to-center distance of anode aluminum rods in an electrolytic bath to be served. The feeding tool 8 is arranged biasedly, and to solve the biasing transportation problem, a discharging port of the hopper 2 is connected with a vertically-lifted biased feed pipe by a hose or flexible tube.

What is claimed is:

1. A tool trolley for an electrolysis multifunctional machine set, characterized by comprising:
a frame;
a hopper fixed to the frame;
a tool rotarytable disposed at the lower portion of the hopper and rotatable around the hopper;
an operating cab disposed below the center of the tool rotarytable;
a crust breaking tool, an anode replacing tool, a grab bucket tool for cleaning anode pit, and a feeding tool, which are flexibly connected to the tool rotarytable around the operating cab; and
a rotation drive mechanism disposed between the hopper and the tool rotarytable.

2. The tool trolley for an electrolysis multifunctional machine set according to claim 1, characterized in that the anode replacing tool (6) is a single anode replacing tool or a double anode replacing tool.

3. The tool trolley for an electrolysis multifunctional machine set according to claim 1, characterized in that
the tool rotarytable is provided with a set of concave openings and expansion slots; and
the crust breaking tool, the anode replacing tool, the grab bucket tool for cleaning anode pit and the feeding tool are flexibly fixed in the concave openings, respectively.

4. The tool trolley for an electrolysis multifunctional machine set according to claim 1, characterized in that the tool rotarytable is provided with a hydraulic station and a power control cabinet.

5. The tool trolley for an electrolysis multifunctional machine set according to claim 1, characterized in that the operating cab is provided therein with an operating console which is rotatable within ±90 degrees.
